(19) United States
(12) Patent Application Publication
(10) Pub. No.: US 2008/0187850 A1
(43) Pub. Date: Aug. 7, 2008

(54) Tunable electrophotographic imaging member and method of making same

(75) Inventors: Lanhui Zhang, Webster, NY (US); Cindy C. Chen, Hsin Chu City (TW)

Correspondence Address: ALIX, YALE & RISTAS, LLP, 750 MAIN STREET, SUITE 1400, HARTFORD, CT, 06103-2721, US

(73) Assignee: Xerox Corporation

(21) Appl. No.: 11/702,769

(22) Filed: Feb. 6, 2007

(51) Int. Cl. G03G 5/00

(52) U.S. Cl. 430/96; 399/107

(57) ABSTRACT

Disclosed herein is an electrophotographic imaging member comprising a supporting substrate and a charge generating layer. The charge generating layer comprises a binder, a first pigment having a first photosensitivity, and a second pigment having a second photosensitivity that is at least 2% greater than the photosensitivity of the first pigment. The first pigment has the same chemical formula, visible spectrum and crystalline structure as the second pigment. An electrostatographic apparatus including the electrophotographic imaging member also is disclosed.

### BACKGROUND

The embodiments disclosed herein relate to electrophotography and more particularly to tunable electrophotographic imaging members.

Numerous photoresponsive devices for electrophotographic imaging systems are known including selenium, selenium alloys, and layered organic and inorganic photoresponsive devices. Examples of layered organic photoresponsive devices include those containing a charge transporting layer and a charge generating layer, or alternatively a single photogenerating layer containing a charge transport material and a charge generating material. An optional overcoat layer is applied on the outer charge transport layer or charge generating layer. A multi-layered organic photoresponsive device typically comprises a conductive substrate coated with a charge generating layer, which in turn is coated with a charge transport layer. In an “inverted” variation of this device, the charge generating layer is applied over the charge transport layer. Examples of charge generating layers that can be employed in these devices include selenium, cadmium sulfide, and phthalocyanine dispersed in binder resin. Examples of materials used in charge transport layers include solutions or dispersions of various diamines, such as those described in commonly assigned U.S. Pat. No. 4,265,990, the disclosure of which is incorporated herein by reference in its entirety.

In the manufacture of photogenerator compounds for electrophotography, it is common practice to reproduce a photopigment synthetic procedure as precisely as possible each and every time the process is used in order to manufacture a very consistent target photogenerator compound material and thereby provide the exact photosensitivity demanded by the specifications of a particular printer or copier model. It is known that the synthesis conditions employed play an irreversible role in imparting to the photogenerator compound certain indelible electrical characteristics which can only moderately be manipulated by subsequent processing steps. A particular printer has electronic and mechanical subsystems that are developed along with the electrophotographic imaging member to achieve a desired image quality. Image quality problems can also arise for particular models in field use that may then require changes in photogenerator specifications, or adjustments in the sensitivity of the electrophotographic imaging member up or down, as required by a particular application, machine, developer design change, or customer requirement. Thus, it is advantageous to be able to manufacture photogenerators, and thereby electrophotographic imaging members, with variations as required during the lifetime of a given printer or copier design program that allows for minimal variation in the electrophotographic imaging member manufacturing conditions.

In the design of electrophotographic imaging members, a single pigment type often cannot fulfill all of various electrical and print performance requirements, such as V_{low}, photosensitivity, ghosting, etc. Commonly assigned U.S. Pat. No. 6,492,080 describes a process for tuning electrophotographic imaging member sensitivity in which two different Type I phthalocyanine products are formed in different solvents. The two pigments are then dry milled and wet treated to form Type II products, which are then blended together with a resin and applied to an electrophotographic imaging member device to form a charge generating layer. The resulting chlorogallium phthalocyanine crystals are used to make an electrophotographic imaging member with the desired level of photosensitivity, as well as excellent dispersability and electrophotographic characteristics. Images formed therefrom do not have fogging or black spots.

It would be useful to develop another pigment-containing coating system that can be quickly and easily adjusted to meet print quality requirements for use with various printers while allowing for simple and convenient preparation.

### SUMMARY

One embodiment is an electrophotographic imaging member including a supporting substrate and a charge generating layer. The charge generating layer comprises a binder, a first pigment having a first photosensitivity, and a second pigment having a second photosensitivity that is at least 2% greater than the photosensitivity of the first pigment. The first pigment has the same chemical formula, visible spectrum and crystalline structure as the second pigment.

Another embodiment is a coating system for a charge generating layer of an electrophotographic imaging member. The coating system comprises a mixture of a binder, a solvent, a first pigment having a first photosensitivity and a second pigment having a second photosensitivity that is at least 2% greater than the photosensitivity of the first pigment. The first pigment has the same chemical formula, visible spectrum and crystalline structure as the second pigment.

Yet another embodiment is an electrostatographic apparatus including a charging component, an electrophotographic imaging member, a transfer component, a development component, and a fixing component. The electrophotographic imaging member includes a supporting substrate and a charge generating layer. The charge generating layer comprises a binder and a first pigment having a first photosensitivity and a second pigment having a second photosensitivity that is at least 2% greater than the photosensitivity of the first pigment. The first pigment has the same chemical formula, visible spectrum and crystalline structure as the second pigment.

A further embodiment is a method of forming an electrophotographic imaging member comprising obtaining a substrate, combining a first pigment having a first photosensitivity and a second pigment having a second photosensitivity that is at least 2% greater than the photosensitivity of the first pigment with a binder to form a pigment-binder mixture, and coating the pigment-binder mixture on the substrate. The first pigment has the same chemical formula, visible spectrum and crystalline structure as the second pigment.

### DETAILED DESCRIPTION

By combining various ratios of two or more photosensitive pigments having the same chemical formula, visible spectrum and crystalline structure but different photosensitivities, charge generating layers can be formed in which the electrical and print quality requirements can be met for a variety of different printers and printing systems. A variable formulation of the type described herein simplifies the manufacturing process by enabling a small group of different pigments to be used in efficiently producing electrophotographic imaging members with charge generating layers having a number of different values of photosensitivity.

As used herein, “substrate” refers to a base layer of a multilayered electrophotographic imaging member. The term “charge generating layer” refers to a layer of set of layers of an electrophotographic imaging member that contain a charge generating material. In some cases the charge generating layer also contains a charge transport material and therefore functions as both a charge generating layer and a charge transport layer. “Photosensitivity” as used herein refers to sensitivity to the action of radiant energy. “Crystalline structure” herein refers to crystal type. “Compatible” as used herein refers to physical and chemical compatibility of different pigments such that they can be mixed and then milled, or milled and then mixed, to form a uniform dispersion of the different pigments.

As used herein, the term “printer” encompasses any apparatus, such as a digital copier, bookmaking machine, facsimile machine, multi-function machine, etc. that performs a print outputting function for any purpose.

The electrophotographic imaging member has a flexible or rigid substrate with an electrically conductive surface or coating. An optional hole blocking layer may be applied to the surface or coating. If used, the hole blocking layer is capable of forming an electronic barrier to holes between an adjacent electrophotographic charge generating layer and the underlying surface or coating. An optional adhesive layer may be applied to the hole-blocking layer.

The one or more electrophotographic imaging layers are formed on the optional adhesive layer, optional hole blocking layer, or directly on the substrate surface or substrate coating. The imaging layer may be a single layer that performs both charge generating and charge transport functions, or it may comprise multiple layers such as a charge generating layer and a separate charge transport layer. When separate charge generating and charge transport layers are employed, the charge generating layer usually is applied before the charge transport layer. However, in some cases the charge generating layer is located on top of the charge transport layer.

The charge generating layer includes a binder and at least two photogenerating pigments. A mixture of two or more pigments having the same chemical formula, visible spectrum and crystallinity but different photosensitivites is used in order to achieve desired electrical properties and print quality. As a non-limiting example, a mixture of two or more chlorogallium phthalocyanine pigments can be used. A solvent, which may be a single type of solvent or a mixture of solvents, usually is also included. In some cases, the binder comprises a carboxyl-modified vinyl chloride-vinyl acetate copolymer. The first and second pigments usually have substantially the same chemical properties.

Good results can be obtained when the pigments are phthalocyanines. Suitable pigments include but are not limited to phthalocyanines that exhibit a sufficiently small particle size that they are useful as charge generators in an electrophotographic imaging member. Metal phthalocyanines such as gallium phthalocyanine can be used. The pigment particles of chlorogallium phthalocyanine typically have a size of about 40 to about 1000 nm, or about 80 to about 500 nm, or about 120 to about 250 nm. Other useful pigments include, but are not limited to, benzimidazole perylene (BzP).

The second pigment has a photosensitivity that is at least 2% greater than the photosensitivity of the first pigment. In many cases, the second pigment has a photosensitivity that is about 5% to about 30% greater than the photosensitivity of the first pigment. Often, the second pigment has a photosensitivity that is about 5% to about 20% greater than the photosensitivity of the first pigment.

Generally, two pigments are used in a weight ratio of about 1:99 to about 99:1, or about 10:90 to about 90:10, or about 20:80 to about 80:20. If three different pigments are used, the amount of each pigment typically is 1-98 parts per 100 total parts of pigment in the mixture.

Chlorogallium phthalocyanine (ClGaPc) pigments are available in multiple types, including Type A, Type B and Type C. The properties of ClGaPc Type A pigment (ClGaPc-A), ClGaPc Type B pigment (ClGaPc-B) and ClGaPc Type C pigment (ClGaPc-C) are very similar to each other, as ClGaPc Types B and C are made by heat treating ClGaPc Type A pigment. ClGaPc Types A, B and C pigments have the same chemical formula, visible spectrum, and crystalline structure. However each of Type A, Type B and Type C possesses a different photosensitivity due to different heat treatment histories of the three types. Due to their similarities they are compatible with each other both before and after milling. Thus, two or three of the Type A, Type B and Type C pigments can be mixed together and then milled, or can be separately milled and subsequently mixed. Mixing pigments before milling allows for the convenience of requiring only one batch of milling, which is beneficial for small scale manufacturing. Separate milling allows for rapid adjustment of ratios of the two or more pigments.

For a specific machine design, i.e., a specific speed and photoreceptor configuration, a charge generating (CG) layer with single ClGaPc Type C pigment provides a V_{low} range of 230-290V or even broader. When its photosensitivity falls near the lower limit (higher V_{low} limit), it does not have sufficient photosensitivity. In contrast, a CG layer with single ClGaPc Type B provides a V_{low} range of 180-240 V. When its photosensitivity falls in the higher limit, it will have too high photosensitivity. In either case, the photosensitivity may not be able to fulfill the machine's photosensitivity requirement and therefore the print quality requirement. When chlorogallium phthalocyanine Types B and C are combined, the photosensitivity can be tuned to the targeted value by adjusting the mixing ratio of two types of pigment. In other embodiments, ClGaPc Type A is combined with one or both of ClGaPc Types B and C in order to increase photosensitivity of a charge generating layer.

In one test, the photosensitivity −(dV/dE) of ClGaPc-A was found to be 139+/−6 kVm²/J, the photosensitivity of ClGaPc-B was 130+/−6 kVm²/J, and the photosensitivity of Type C was 120+/−6 kVm²/J. It is noted that actual measured values of photosensitivity will depend upon the coating technique, binder type, substrates and other layers, etc. but that the relative differences in photosensitivities of pigments having the same visible spectrum, crystallinity and chemical composition but different heat treatment histories will remain generally the same provided that the same test is used to measure photosensitivity of each pigment.

Suitable binders for use with in the charge generating layer include but are not limited to thermoplastic and thermosetting resins such as polycarbonates, polyesters including poly(ethylene terephthalate), polyurethanes including poly(tetramethylene hexamethylene diurethane), polystyrenes including poly(styrene-co-maleic anhydride), polybutadienes including polybutadiene-graft-poly(methyl acrylate-co-acrylontrile), polysulfones including poly(1,4-cyclohexane sulfone), polyarylethers including poly(phenylene oxide), polyarylsulfones including poly(phenylene sulfone), polyethersulfones including poly(phenylene oxide-co-phenylene sulfone), polyethylenes including poly(ethylene-co-acrylic acid), polypropylenes, polymethylpentenes, polyphenylene sulfides, polyvinyl acetates, polyvinylbutyrals, polysiloxanes including poly(dimethylsiloxane), polyacrylates including poly(ethyl acrylate), polyvinyl acetals, polyamides including poly(hexamethylene adipamide), polyimides including poly(pyromellitimide), amino resins including poly(vinyl amine), phenylene oxide resins including poly(2,6-dimethyl-1,4-phenylene oxide), terephthalic acid resins, phenoxy resins including poly(hydroxyethers), epoxy resins including poly([(o-cresyl glycidyl ether)-co-formaldehyde], phenolic resins including poly(4-tert-butylphenol-co-formaldehyde), polystyrene and acrylonitrile copolymers, polyvinylchlorides, polyvinyl alcohols, poly-N-vinylpyrrolidinones, vinyl acetate copolymers, acrylate copolymers, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and the like, and combinations thereof. These polymers may be block, random, or alternating copolymers.

Suitable binders include terpolymers and tetrapolymers. Non-limiting examples of terpolymers which may be utilized as the binder include the reaction product of vinyl chloride, vinyl acetate and maleic acid. In one embodiment, the terpolymer may be formed from a reaction mixture having from about 80 percent to about 87 percent by weight vinyl chloride, from about 12 percent to about 18 percent by weight vinyl acetate and up to about 2 percent by weight maleic acid, in embodiments from about 0.5 percent to about 2 percent by weight maleic acid, based on the total weight of the reactants for the terpolymer. Additional description of suitable binders can be found in U.S. Patent Publication No. 2006/0257768, the contents of which are incorporated by reference herein in their entirety.

The overall compounding weight ratio of the pigment to the binder typically, but not necessarily, is from about 0.5:99.5 to 95:5, or about 1:99 to 95:5, or about 10:90 to 85:15.

The pigments usually are dispersed in a solvent. Any suitable solvent can be used that dissolves the binder. Typical low boiling solvents include, but are not limited to alkylene halides, alkylketones, alcohols, ethers, esters, and mixtures thereof. Examples of suitable solvents include tetrahydrofuran (THF), methylene chloride, acetone, methanol, ethanol, isopropyl alcohol, ethyl acetate, methylethyl ketone, 1,1,1-trichloroethane, 1,1,2-trichlororethane, chloroform, 1,2-dichloroethane and combinations thereof. Suitable high boiling point solvents which can be used in combination with each other or in combination with low boiling solvents include alkylene halides, alkylketones, alcohols, ethers, esters, aromatics and mixtures thereof. Additional non-limiting examples of suitable solvents include n-butyl acetate (NBA), methyl isobutyl ketone (MIBK), cyclohexanone, toluene, xylene, monochlorobenzene, dichlorobenzene, 1,2,4 trichlorobenzene, mixtures of one or more of the foregoing solvents, and the like. Some solvents that are particularly useful in combination with ClGaPc pigments and a carboxyl-modified chloride/vinyl acetate copolymer binder are xylene and n-butyl acetate.

Any suitable technique can be used to disperse the pigment particles in the film forming binder. Typical dispersion techniques include, for example, ball milling, roll milling, milling in vertical attritors, sand milling, dynomill milling, nanomizer milling, Cavipro milling and the like. The pigment particles can be combined prior to dispersing in the binder solution or separately dispersed in a binder solution and the resulting dispersions combined in the desired proportions for coating application. Blending of the dispersions may be accomplished by any suitable technique. Furthermore, a separate concentrated mixture of each type of photoconductive particles and binder solution may be initially milled and thereafter combined and diluted with additional binder solution for coating mixture preparation purposes.

Any suitable technique may be utilized to apply the coating to the substrate. Typical coating techniques include dip coating, roll coating, spray coating, blade coating, wire bar coating, bead coating, die coating, slot coating, curtain coating, rotary atomizers, and the like. The coating techniques may use a wide concentration of solids. As used herein, the term “solids” refers to the pigment particle and binder components of the coating dispersion.

Drying of the deposited coating may be effected by any suitable conventional technique such as oven drying, infra red radiation drying, air drying and the like.

The electrophotographic charge generating layer containing the pigment and binder typically has a thickness in the range of 0.05 to about 30 microns, or about 0.1 to about 2 microns, or about 0.15 to about 1 micron, although the thickness can be outside these ranges.

The following examples show certain embodiments and are intended to be illustrative only. The materials, conditions, process parameters and the like recited herein are not intended to be limiting.

### EXAMPLE 1

Two separate pigment dispersions were prepared in a binder/solvent solution for use in preparing charge generating layers of electrophotographic imaging members. The first, designated as 1-1, contained chlorogallium phthalocyanine Type C pigment (ClGaPc Type C, Fuji Xerox, Ltd., Japan) having a chemical formulation C₃₂H₁₆N₈ClGa and a molecular weight of 617.71, and a carboxyl-modified chloride/vinyl acetate copolymer binder (VMCH, Dow Chemical) in a solvent of n-butyl acetate and xylene. The weight ratio of n-butyl acetate to xylene was 41/59. The second, designated as 1-2, contained chlorogallium phthalocyanine Type B pigment (ClGaPc Type B, Fuji Xerox, Ltd., Japan) having the same chemical formulation and molecular weight as ClGaPc Type C, and a carboxyl-modified chloride/vinyl acetate copolymer binder (VMCH, Dow Chemical) in the same type of solvent blend of n-butyl acetate and xylene as was used in 1-1. In each case, the final pigment:binder weight ratio was 60/40 and the solids content of each dispersion was 7.5%. Each dispersion was processed by dynomill milling and certrifugation. A portion of each of the two dispersions were then combined in a 2:1 mixture of Type C dispersion to Type B dispersion such that the final pigment binder weight ratio [ClGaPc-B+ClGaPc-C]/VMCH was 60/40 and the solids content was 7.5%. This dispersion was designated as 1-3.

Electrophotographic imaging member devices were prepared by coating aluminum substrates (30×404 mm, rough lathed) with an undercoat (UC) layer, a charge generating (CG) layer and a charge transport (CT) layer sequentially. The undercoat layer was of a 3-component type and had a final thickness of about 1 micron. The charge generating layer was a Tsukiage coating containing pigment dispersion 1-1, 1-2 or 1-3, which was then dried at room temperature for 6 minutes before coating the subsequent layer, and had a thickness of about 0.2-0.3 microns. The charge transport layer was formed from a charge transport mixture of polytetrafluoroethylene, N,N′-diphenyl-N,N′-bis(alkylphenyl)-1,1-biphenyl-4,4′-diamine (mTBD) and polycarbonate resin (PCZ400 from Mitsubishi Chemical Co.) in a solvent mixture of tetrahydrofuran and toluene. The charge transport layer was applied in a single dip coating and was dried at 120 Deg. C. for 40 minutes. The charge transport layer had a dried thickness of 29 microns. In one set of examples the coating speed of the charge generating layer was 160 mm/min and in another set the coating speed of the charge generating layer was 180 mm/min.

The resulting electrophotographic imaging member devices were electrically tested with a cyclic scanner set to obtain 100 charge-erase cycles immediately followed by an additional 100 cycles, sequences at 2 charge-erase cycles and 1 charge-expose-erase cycle, wherein the light intensity was incrementally increased with cycling to produce a photoinduced discharge curve from which the photosensitivity was measured. The scanner was equipped with a single wire corotron (5 centimeters wide) set to deposit 70 nanocoulombs/cm² of charge on the surface of the drum devices.

The devices were tested in the negative charging mode. The exposure light intensity was incrementally increased by means of regulating a series of neutral density filters, and the exposure wavelength was controlled by a band filter at 780±5 nanometers. The exposure light source was a 1,000 watt Xenon arc lamp white light source.

The drum was rotated at a speed of 66 rpm to produce a surface speed of 103.7 millimeters/second or a cycle time of 0.9 seconds. The electrostatographic simulation was carried out in an environmentally controlled light tight chamber at ambient conditions (50 percent relative humidity and 21° C.). The results of these tests are set forth below in Table 1, where V_{low} is the residual voltage after a given amount of light exposure, respectively; V_{depl} represents the leakage voltage, or the inability of the device to hold a small amount of applied charge. DiThk is dielectric thickness, which is the ratio of the actual thickness to the material dielectric constant. Vₑᵣₐₛₑ is average voltage after erase exposure.

In Table 1, the dark decay of the electrophotographic imaging member was measured by monitoring the surface potential after applying a single charge cycle of 50 nanocoulombs/cm² while maintaining the electrophotographic imaging member in dark (without light exposure). Photosensitivity −(dV/dE) was calculated from the initial discharge rate at low exposure intensity, determined at about 70 percent of the initial voltage or V_{zero} (of about 0 to about 0.7 erg/cm² exposure). The voltage of the device (V_{low}) was measured at exposure levels of 2.8 erg/cm² to record the residual voltage obtained after the device is partially exposed. The charge capacity was measured by applying increasing amounts of charge from about 2 to about 120 nC/cm², and monitoring the resulting voltage (with erase) to generate a charge-voltage curve. The low field voltage depletion was calculated from a linear regression of the charge-voltage curve, with the V_{depl} voltage represented by the intercept at zero applied charge.

The results on Table 1 show that by using the mixture of two pigments in Examples 1X and 1Y, the photosensitivity can be tuned to a desired value while the other favorable properties of print quality, including low background and low ghosting, are maintained.

### PROPHETIC EXAMPLE 2

The procedure of Example 1 is repeated with the exception that the two types of pigments are mixed before milling and the mixtures are then milled together. It is estimated that the results would be generally comparable to those shown on Table 1 due to the chemical and physical similarities of pigment types B and C.

### PROPHETIC EXAMPLE 3

The procedure of Example 1 is repeated with the exception that the pigment binder ratio is reduced to 55:45. It is expected that photosensitivity would decrease relative to the results of Example 1.

### PROPHETIC EXAMPLE 4

The procedure of Example 1 is repeated with the exception that the ratio of the Type C dispersion to the Type B dispersion was reduced to 50:50. It is estimated that photosensitivity would increase relative to the results of Example 1.

### PROPHETIC EXAMPLE 5

The procedure of Example 1 is repeated with the exception that half of the ClGaPc Type B is replaced with ClGaPc Type A in the same type of solvent, resulting in a ratio of 4:1:1 parts of Type C, Type B and Type A, respectively. It is expected that photosensitivity would be higher than the results of Example 1.

### PROPHETIC EXAMPLE 6

The procedure of Example 1 is repeated with the exception that ClGaPc Type A is used in place of ClGaPc Type B. It is expected that photosensitivity would be higher than the results of Example 1.

### PROPHETIC EXAMPLE 7

The procedure of PROPHETIC EXAMPLE 2 is repeated with the exception that ClGaPc-A is used in place of ClGaPc-B. It is expected that photosensitivity would be higher than the photosensitivity expected in PROPHETIC EXAMPLE 2.

### PROPHETIC EXAMPLE 8

The procedure of Example 1 is repeated with the exception that ClGaPc-A is used in place of ClGaPc-C. It is estimated that photosensitivity would be higher than the results of Example 1.

### PROPHETIC EXAMPLE 9

The procedure of PROPHETIC EXAMPLE 2 is repeated with the exception that ClGaPc-A is used in place of ClGaPc-C. It is expected that photosensitivity would be higher than the results of PROPHETIC EXAMPLE 2.

### PROPHETIC EXAMPLE 10

The procedure of Example 1 is repeated with the exception that the ClGaPc pigments are replaced with two oxo-titanium phthalocyanine pigments, the binder is polyvinyl butyral (BM-1) and the solvent is n-butyl acetate. The oxo-titanium phthalocyanine pigments have the same chemical composition, visible spectrum and crystallinity as one another but different heat treatment histories, resulting in different photosensitivities.

It is estimated that photosensitivity can be tuned by adjusting the ratio of the two pigments while the other favorable properties, including dispersion quality, are maintained.

### PROPHETIC EXAMPLE 11

The procedure of PROPHETIC EXAMPLE 10 is repeated with the exception that the two types of pigments are mixed before milling and the mixtures are then milled together. The results are expected to be generally comparable to the results of PROPHETIC EXAMPLE 10 due to the chemical and physical similarities of the two pigment types.

### PROPHETIC EXAMPLE 12

The procedure of Example 1 is repeated with the exception that the ClGaPc pigments are replaced with benzimidazole perylene (BzP), the binder is polyvinyl butyral (BM-1), and the solvent is n-butyl acetate. The benzimidazole perylene pigments have the same chemical composition, visible spectrum and crystallinity as one another but different heat treatment histories, resulting in different photosensitivities.

It is expected that photosensitivity can be tuned by adjusting the ratio of the two pigments while the other favorable properties, including dispersion quality, are maintained.

### PROPHETIC EXAMPLE 13

The procedure of PROPHETIC EXAMPLE 12 is repeated with the exception that the two types of BzP pigments are mixed before milling and the mixtures are then milled together. The results are expected to be generally comparable to the results of PROPHETIC EXAMPLE 12 due to the chemical and physical similarities of the two BzP pigments.

The embodiments disclosed herein can be used to make an electrophotographic imaging member for an electrostatographic apparatus comprising a charging component, an electrophotographic imaging member, a transfer component, a development component, and a fixing component.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

TABLE 1

| | | | | V_{low} | Photosensitivity - | | Dark | |
|---|---|---|---|---|---|---|---|---|
| | | V_{dept} | | (2.8 | (dV/dE) | Vₑᵣₐₛₑ | decay | |
| Device ID | CGL | (V) | DiThk | erg) | (kVm²/J) | (V) | (V/s) | Notes |
| Control 1 | 1-1 160 mm/min | 82 | 10.1 | 252 | 201 | 46 | 15 | 1-1 = ClGaPc-C/VMCH/NBN/xyl |
| Control 2 | 1-2 160 mm/min | 79 | 10.2 | 215 | 233 | 23 | 17 | 1-2 = ClGaPc-B/VMCH/NBA/xyl |
| Ex. 1X | 1-3 160 mm/min | 67 | 10.0 | 247 | 209 | 39 | 15 | 1-3 = [ClGaPc-B + ClGaPc-C] (1:2) |
| Control 3 | 1-1 180 mm/min | 94 | 10.1 | 242 | 206 | 44 | 18 | 1-1 = ClGaPc-C/VMCH/NBA/xyl |
| Control 4 | 1-2 180 mm/min | 82 | 10.3 | 212 | 239 | 24 | 18 | 1-2 = ClGaPc-B/VMCH/NBA/xyl |
| Ex. 1Y | 1-3 180 mm/min | 78 | 10.0 | 229 | 214 | 29 | 16 | 1-3 = [ClGaPc-B + ClGaPc-C] (1:2) |

What is claimed is:

1. An electrophotographic imaging member comprising a supporting substrate and a charge generating layer, the charge generating layer comprising a binder and a first pigment having a first photosensitivity and a second pigment having a second photosensitivity that is at least 2% greater than the first photosensitivity of the first pigment, the first pigment having the same chemical formula, visible spectrum and crystalline structure as the second pigment.

2. The electrophotographic imaging member of claim 1 wherein the first and second pigments comprise at least one member selected from the group consisting of phthalocyanine pigments and benzimidazole perylene pigments.

3. The electrophotographic imaging member of claim 1, wherein the first and second pigments have substantially the same chemical properties.

4. The electrophotographic imaging member of claim 1, wherein the first and second pigments are metal phthalocyanines.

5. The electrophotographic imaging member of claim 1, wherein the first and second pigments are gallium phthalocyanines.

6. The electrophotographic imaging member of claim 1, wherein the first and second pigments are chlorogallium phthalocyanines.

7. The electrophotographic imaging member of claim 1, wherein the pigment-binder mixture contains a weight ratio of the first pigment and the second pigment in the range of about 1:99 to about 99:1.

8. The electrophotographic imaging member of claim 1, wherein the pigment-binder mixture contains a weight ratio of the first pigment and the second pigment in the range of about 10:90 to about 90:10.

9. The electrophotographic imaging member of claim 1, wherein the binder comprises at least one member selected from the group consisting of polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polyvinyl acetates, polyvinylbutyrals, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchlorides, polyvinyl alcohols, poly-N-vinylpyrrolidinones, vinyl acetate copolymers, acrylate copolymers, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

10. The electrophotographic imaging member of claim 1, wherein the weight ratio of pigment to binder is in the range of 0.5:99.5 to 95:5.

11. The electrophotographic imaging member of claim 1, wherein the binder comprises a carboxyl-modified vinyl chloride-vinyl acetate copolymer.

12. The electrophotographic imaging member of claim 1, wherein the charge generating layer further includes a third pigment having the same chemical formula and crystalline structure as the first and second pigments and a photosensitivity that is at least 2% greater than the photosensitivity of the second pigment.

13. The electrophotographic imaging member of claim 1, further comprising a charge transport layer formed on or beneath the charge generating layer.

14. A coating system for a charge generating layer of an electrophotographic imaging member, the coating system comprising a mixture of a binder, a solvent, a first pigment having a first photosensitivity and a second pigment having a second photosensitivity that is at least 2% greater than the first photosensitivity of the first pigment, the first pigment having the same chemical formula, visible spectrum and crystalline structure as the second pigment.

15. The coating system of claim 14, wherein the first and second pigments comprise at least one member selected from the group consisting of phthalocyanine pigments and benzimidazole perylene pigments.

16. The coating system of claim 14, wherein the first and second pigments are metal phthalocyanines.

17. The coating system of claim 14, wherein the binder comprises at least one member selected from the group consisting of polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polyvinyl acetates, polyvinylbutyrals, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchlorides, polyvinyl alcohols, poly-N-vinylpyrrolidinones, vinyl acetate copolymers, acrylate copolymers, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

18. The coating system of claim 14, wherein the photosensitivity of the electrophotographic imaging member formed therefrom is determined in part by the ratio of the first and second pigments in the mixture.

19. An electrostatographic apparatus comprising a charging component, an electrophotographic imaging member, a transfer component, a development component, and a fixing component, the electrophotographic imaging member including a supporting substrate and a charge generating layer, the charge generating layer comprising a binder and a first pigment having a first photosensitivity and a second pigment having a second photosensitivity that is at least 2% greater than the first photosensitivity of the first pigment, the first pigment having the same chemical formula, visible spectrum and crystalline structure as the second pigment.

20. A method of forming an electrophotographic imaging member, comprising:
obtaining a substrate,
combining a first pigment having a first photosensitivity and a second pigment having a second photosensitivity that is at least 2% greater than the first photosensitivity of the first pigment with a binder to form a pigment-binder mixture, the first pigment having the same chemical formula, visible spectrum and crystalline structure as the second pigment, and
coating the pigment-binder mixture on the substrate.

21. The method of claim 20, wherein combining includes mixing the first and second pigments with the binder and a solvent, and subsequently milling the pigment-binder mixture.

22. The method of claim 20, wherein combining includes separately milling the first and second pigments with the binder and a solvent, and subsequently blending the separately milled pigments.
